(19) United States
(12) Patent Application Publication
(10) Pub. No.: US 2017/0288584 A1
(43) Pub. Date: Oct. 5, 2017

(54) POWER TOOL AND MOTOR DRIVE SYSTEM THEREOF

(71) Applicant: Johnson Electric S.A., Murten (CH)

(72) Inventors: Hai Bo MA, Hong Kong (CN); Yuk Tung LO, Hong Kong (CN); Jin Zhou CHEN, Shenzhen (CN); Yong Sheng GAO, Shenzhen (CN); Jian Xun ZOU, Shenzhen (CN); Song CHEN, Shenzhen (CN)

(21) Appl. No.: 15/479,807

(22) Filed: Apr. 5, 2017

(30) Foreign Application Priority Data
Apr. 5, 2016 (CN) 2016 1020 9140.9

(51) Int. Cl. H02P 6/24; B25F 5/00; H02P 6/16; B23Q 11/00; H02P 3/22; H02P 6/08

(52) U.S. Cl. CPC H02P 6/24; H02P 3/22; H02P 6/085; H02P 6/16; B23Q 11/0092; B25F 5/00

(57) ABSTRACT

A motor drive system is provided, which includes: an inverter coupled with two terminals of a power supply, where the inverter includes multiple semi-conductive switch elements and is configured to convert a voltage provided by the power supply to an alternating current to drive a motor; a microcontroller configured to output a drive signal to control an power mode of the semi-conductive switch elements in the inverter; and a rheostat coupled with the microcontroller and configured to provide an input signal to the microcontroller by sliding, where the microcontroller outputs a brake signal to the inverter to control the motor to stop operating when the input signal meets a predetermined condition, and the microcontroller is powered off when the motor stops rotating.

### CROSS REFERENCE TO RELATED APPLICATIONS

This non-provisional patent application claims priority under 35 U.S.C. §119(a) to Chinese Patent Application No. CN201610209140.9, filed with the Chinese Patent Office on Apr. 5, 2016 which is incorporated herein by reference in their entirety.

### FIELD

The disclosure relates to a power tool, and particularly to a motor drive system applicable to the power tool.

### BACKGROUND

Power tools are widely used in industry and daily life. Currently, a switch is turned off by releasing the switch to trigger a microcontroller of the power tool to transmit a brake signal, and a motor of the power tool is controlled to stop operating. The power tool is triggered to stop operating in only a single manner.

### SUMMARY

In view of the above, a motor drive system, a power, which can improve efficiency, are provided according to the present disclosure.

A motor drive system comprises an inverter coupled with two terminals of a power supply, wherein the inverter comprises a plurality of semi-conductive switch elements, and is configured to convert a voltage provided by the power supply to an alternating current to drive a motor; a microcontroller configured to output a drive signal to control an power mode of the plurality of semi-conductive switch elements in the inverter; and a rheostat coupled with the microcontroller and configured to provide an input signal to the microcontroller by sliding, wherein the microcontroller outputs a brake signal to the inverter to control the motor to stop operating when the input signal meets a predetermined condition, and the microcontroller is powered off when the motor stops rotating.

Preferably, the microcontroller outputs the brake signal to the inverter when the input signal provided by the rheostat to the microcontroller is less than a first predetermined voltage value.

Preferably, the rheostat comprises a first fixed contact, a second fixed contact and a movable contact, the first fixed contact and the second fixed contact being respectively coupled with a power supply terminal and a ground terminal of the microcontroller, and the movable contact being coupled with an input terminal of the microcontroller, wherein different input signals are provided by the rheostat to the microcontroller by the movable contact sliding towards the first fixed contact or the second fixed contact, wherein the input signal gradually increases when the movable contact slides towards the first fixed contact, and gradually decreases when the movable contact slides towards the second fixed contact.

Preferably, when the input signal provided by the rheostat to the microcontroller is greater than the first predetermined voltage value, the microcontroller adjusts, according to the input signal, a duty cycle of a PWM signal outputted by the microcontroller to adjust a rotation speed of the motor.

Preferably, the microcontroller outputs the brake signal to the inverter when the input signal provided by the rheostat to the microcontroller is greater than a second predetermined voltage value.

Preferably, the rheostat comprises a first fixed contact, a second fixed contact and a movable contact, the first fixed contact and the second fixed contact being respectively coupled with a ground terminal and a power supply terminal of the microcontroller, and the movable contact being coupled with an input terminal of the microcontroller, wherein different input signals are provided by the rheostat to the microcontroller by the movable contact sliding towards the first fixed contact or the second fixed contact, wherein the input signal gradually decreases when the movable contact slides towards the first fixed contact, and gradually increases when the movable contact slides towards the second fixed contact.

Preferably, when the input signal provided by the rheostat to the microcontroller is less than the second predetermined voltage value, the microcontroller adjusts, according to the input signal, a duty cycle of a PWM signal outputted by the microcontroller to adjust a rotation speed of the motor.

Preferably, the inverter comprises an upper-half bridge and a lower-half bridge, each of the upper-half bridge and the lower-half bridge comprises at least two semi-conductive switch elements, and when performing braking, the microcontroller transmits a PWM signal to alternately control each two of the at least two semi-conductive switch elements of the upper-half bridge to be turned on and each two of the at least two semi-conductive switch elements of the lower-half bridge to be turned on, wherein a motor stator winding of the motor and the turned-on semi-conductive switch elements form a circuit.

Preferably, the microcontroller alternately controls each two of the at least two semi-conductive switch elements of the lower-half bridge of the inverter to be turned on during a first half of a rotation cycle of the motor, and each two of the at least two semi-conductive switch elements of the upper-half bridge of the inverter to be turned on during a second half of the rotation cycle of the motor.

Preferably, when a number of the motor stator winding of the motor is at least two, when performing braking, the microcontroller determines a first motor stator winding which generates a maximum back electromotive force and a second motor stator winding which generates a minimum back electromotive force according to a magnetic pole position of a rotor of the motor, and transmits the PWM signal to alternately control semi-conductive switch elements of the upper-half bridge and semi-conductive switch elements of the lower-half bridge to be turned on, wherein the turned-on semi-conductive switch elements of the upper-half bridge comprises a first semi-conductive switch element which controls the first motor stator winding and a second semi-conductive switch element which controls the second motor stator winding, and the turned-on semi-conductive switch elements of the lower-half bridge comprises a third semi-conductive switch element which controls the first motor stator winding and a fourth semi-conductive switch element which controls the second motor stator winding, whereby the first motor stator winding and the second motor stator winding are shorted with each other via the turned-on first semi-conductive switch element and the turned-on second semi-conductive switch element or shorted with each other via the turned-on third semi-conductive switch element and the turned-on fourth semi-conductive switch element.

Preferably, a position sensor configured to output a Hall signal according to the magnetic pole position of the rotor, the upper-half bridge comprises a first switch, a second switch and a third switch, and the lower-half bridge comprises a fourth switch, a fifth switch and a sixth switch, wherein a node is formed between the first switch and the fourth switch, a node is formed between the second switch and the fifth switch, and a node is formed between the third switch and the sixth switch, and wherein the microcontroller turns on the fifth switch and the sixth switch when the Hall signal outputted by the position sensor is 101, turns on the fourth switch and the fifth switch when the Hall signal outputted by the position sensor is 100, turns on the fourth switch and the sixth switch when the Hall signal outputted by the position sensor is 110, turns on the second switch and the third switch when the Hall signal outputted by the position sensor is 010, turns on the first switch and the second switch when the Hall signal outputted by the position sensor is 011, and turns on the first switch and the third switch when the Hall signal outputted by the position sensor is 001.

Preferably, when a number of the motor stator winding of the motor is one, when performing braking, the microcontroller transmits the PWM signal according to a magnetic pole position of a rotor, so as to alternately control semi-conductive elements of the upper-half bridge to be turned on and semi-conductive elements of the lower-half bridge to be turned on, the motor stator winding and the turned-on semi-conductive elements forming a circuit.

Preferably, a position sensor configured to output a Hall signal according to the magnetic pole position of the rotor, wherein the inverter comprises an upper-half bridge and a lower-half bridge, the upper-half bridge comprises a first switch and a second switch, and the lower-half bridge comprises a third switch and a fourth switch, wherein a node is formed between the first switch and the third switch, and a node is formed between the second switch and the fourth switch, and wherein the microcontroller turns on the third switch and the fourth switch when the Hall signal outputted by the position sensor is 10, and turns on the first switch and the second switch when the Hall signal outputted by the position sensor is 01.

Preferably, a switch body which is coupled between the power supply and the microcontroller, and is configured to be opened after the microcontroller outputs the brake signal for a first predetermined period of time, wherein when the motor stops rotating, the switch body disconnects the power supply and the microcontroller from each other, and the power supply stops supplying power to the microcontroller.

Preferably, a trigger configured to drive the switch body and the rheostat to move when manually operated by a user, wherein when the trigger is pressed, the trigger drives the switch body to be closed and the switch body connects the power supply with the microcontroller, and drives the rheostat to move and the microcontroller adjusts, according to the input signal provided by the rheostat to the microcontroller, a duty cycle of a PWM signal outputted by the microcontroller, to adjust a rotation speed of the motor; and when the trigger is released, the trigger drives the rheostat to move and the input signal provided by the rheostat to the microcontroller triggers the microcontroller to output the brake signal, and drives the switch body to move such that the switch body is opened after the microcontroller outputs the brake signal for the first predetermined period of time.

Preferably, a switch body coupled between the power supply and the microcontroller, and a trigger configured to drive the switch body to move when manually operated by a user, wherein when the trigger is released, the trigger drives the switch body to be opened after the trigger is released for a second predetermined period of time, wherein when the motor stops rotating, the switch body disconnects the power supply and the microcontroller from each other, and the power supply stops supplying power to the microcontroller.

A power tool comprises a housing, a working head extended out of the housing, a motor for driving the working head, and the motor drive system as described-above.

### BRIEF DESCRIPTION OF THE DRAWINGS

FIG. 1 is a block diagram of a motor drive system according to one embodiment.

FIG. 2 is a schematic diagram of a correspondence between a state of a switch body and an input signal according to one embodiment.

FIG. 3 is a circuit diagram of a motor drive system according to one embodiment.

FIG. 4 is a waveform diagram of Hall signals and back electromotive forces of the motor drive system of FIG. 2.

FIG. 5 is a schematic diagram of the motor drive system to perform braking when the Hall signal is 101 according to the embodiment.

FIG. 6 is a circuit diagram of a motor drive system according to another embodiment.

FIG. 7 is a schematic diagram of the motor drive system to perform braking when the Hall signal is 10 according to another embodiment.

FIG. 8 is a schematic diagram illustrating a power tool to which the above motor drive system is applied.

### DETAILED DESCRIPTION OF THE EMBODIMENTS

Hereinafter, particular embodiments of the present disclosure are described in detail in conjunction with the drawings, so that technical solutions and other beneficial effects of the present disclosure are apparent. It can be understood that the drawings are provided only for reference and explanation, rather than limiting the present disclosure. Dimensions shown in the drawings are only for ease of clear description, without defining a proportional relationship.

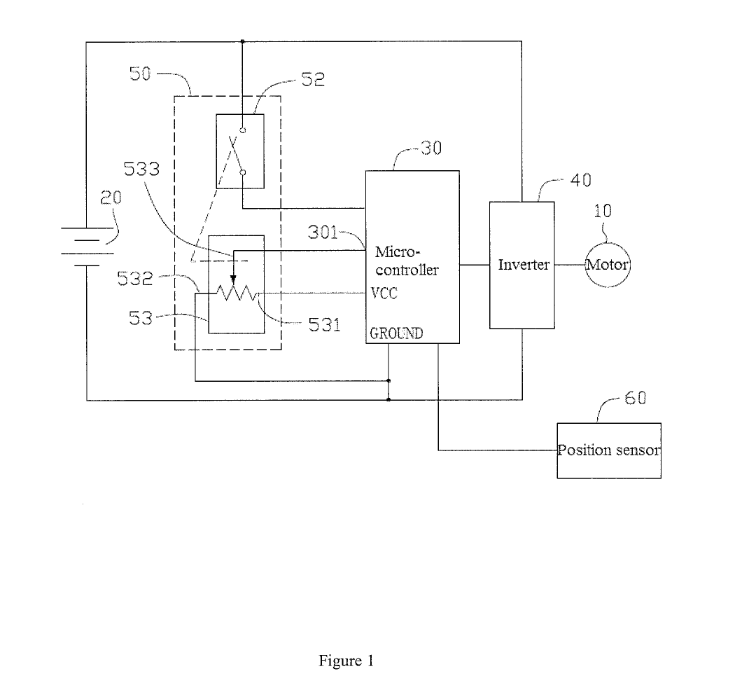

Reference is made to FIG. 1, where a motor drive system according to one embodiment is configured to drive a motor to operate or to stop operating. In this embodiment, the motor 10 is a brushless direct current (BLDC) motor, which includes a stator and a rotor rotatable relative to the stator, where the stator includes a stator core and a motor stator winding wound on the stator core. The stator core may be made of soft magnetic materials such as pure iron, cast iron, cast steel, electrical steel, and silicon steel. The rotor is provided with a permanent magnet and a cooling fan.

A power supply 20 supplies electric power to the motor 10. In this embodiment, the power supply 20 can be a lithium ion battery. In other embodiments, the power supply 20 may be other types of batteries such as a nickel-metal hydride battery, a lithium-polymer battery, a fuel cell, and a solar battery. The power supply 20 may be a rechargeable battery which is detachably mounted within a power tool provided with the motor 10. In addition, the power supply 20 may also be the mains supply.

The motor drive system includes a microcontroller 30, an inverter 40, a trigger switch 50 and a position sensor 60.

In this embodiment, the microcontroller 30 is configured to output a signal to control a power mode of the inverter 40. In other embodiments, the motor drive system can further include a voltage regulator which is configured to buck a voltage supplied by the power supply 20 and provide it to the microcontroller 30, and a driver configured to boost or perform current amplification on a signal outputted by the microcontroller 30 and transmit it to the inverter 40.

The microcontroller 30 is configured to output a signal to drive semi-conductive switch elements of the inverter 40, so as to control a power mode of the motor 10, thereby implementing commutation and/or speed control of the motor. In this embodiment, the microcontroller 30 outputs a drive signal to control the power mode of the motor 10 so as to drive the motor 10 to operate or to stop the motor 10 from operating. In this embodiment, the drive signal is a PWM signal. In this embodiment, when performing braking, the drive signal is a brake signal. Therefore, when performing braking, the microcontroller 30 outputs the brake signal to control the power mode of the motor 10 to stop the motor from operating.

The inverter 40 is coupled with two ends of the power supply 20 and is coupled with the motor 10. The inverter 40 may be a three-phase inverter which includes an upper-half bridge and a lower-half bridge, each of which includes at least two semi-conductive switch elements. In this embodiment, the semi-conductive switch elements are MOSFETs. The inverter 40 is configured to convert a voltage supplied by the power supply 20 into an alternating current to drive the motor 10.

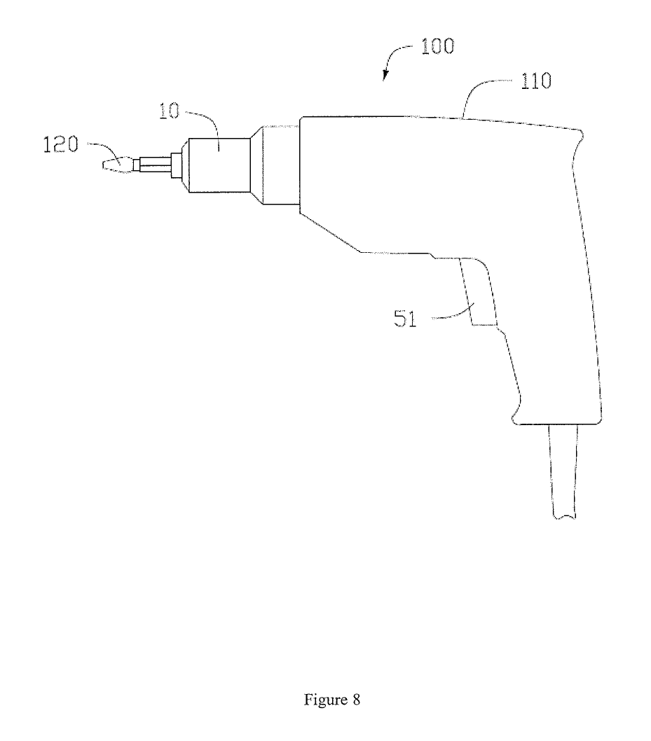

In this embodiment, the trigger switch 50 includes a trigger 51 (as shown in FIG. 8), a switch body 52, and a rheostat 53. The trigger 51 is configured to drive the switch body 52 and the rheostat 53 to move when manually operated by a user.

The switch body 52 is coupled between the power supply 20 and the microcontroller 30, and is configured to connect the power supply 20 with the microcontroller 30 or to disconnect the power supply 20 and the microcontroller 30 from each other. When the switch body 52 is closed, the power supply 20 supplies power to the microcontroller 30 via the switch body 52, and when the switch body 52 is opened, the power supply 20 stops supplying power to the microcontroller 30.

In this embodiment, the rheostat 53 can be a slide rheostat or a potentiometer. The rheostat 53 is coupled with the microcontroller 30. The rheostat 53 can include a first fixed contact 531, a second fixed contact 532 and a movable contact 533. In this embodiment, the first fixed contact 531 and the second fixed contact 532 are respectively coupled with a power supply terminal VCC and a ground terminal GROUND of the microcontroller 30, and the movable contact 533 is coupled with an input terminal 301 of the microcontroller 30. The movable contact 533 is configured to provide different input signals to the microcontroller 30 by sliding towards the first fixed contact 531 or the second fixed contact 532. In this embodiment, when the trigger 51 is pressed, the trigger 51 drives the movable contact 533 to slide towards the first fixed contact 531; and when the trigger 51 is released, the trigger 51 drives the movable contact 533 to slide towards the second fixed contact 532. In this embodiment, an input signal provided by the rheostat 53 to the microcontroller 30 is a voltage value. In this embodiment, when the input signal provided by the rheostat 53 to the microcontroller 30 is less than a first predetermined voltage value (for example, 0.5 volts, 0.8 volts, or the like), the microcontroller 30 outputs the brake signal to the inverter 40; and when the input signal provided by the rheostat 53 to the microcontroller 30 is greater than the first predetermined voltage value (for example, 0.5 volts, 0.8 volts, or the like), the microcontroller 30 adjusts a duty cycle of the PWM signal outputted by the microcontroller 30 according to the input signal, so as to change a rotation speed of the motor 10.

In this embodiment, when the trigger 51 is pressed, the trigger 51 drives the switch body 52 to be closed, where the power supply 20 supplies power to the microcontroller 30 via the switch body 52. Meanwhile, when the trigger 51 is pressed, the trigger 51 drives the movable contact 533 of the rheostat 53 to slide towards the first fixed contact 531. The input signal provided by the rheostat 53 to the microcontroller 30 is changed to different voltage values according to different forces applied on the trigger 51, such that the rotation speed of the motor 10 varies with the forces applied on the trigger 51. For example, when the applied force is 8 Newtons, the input signal provided by the rheostat 53 to the microcontroller 30 is 8 volts, and the rotation speed of the motor 10 reaches 800 revolutions per second; when the applied force is changed from 8 Newtons to 5 Newtones, the input signal provided by the rheostat 53 to the microcontroller 30 is changed from 0.8 volts to 0.5 volts, and the rotation speed of the motor 10 is changed from 800 revolutions per minute (rpm) to 500 rpm.

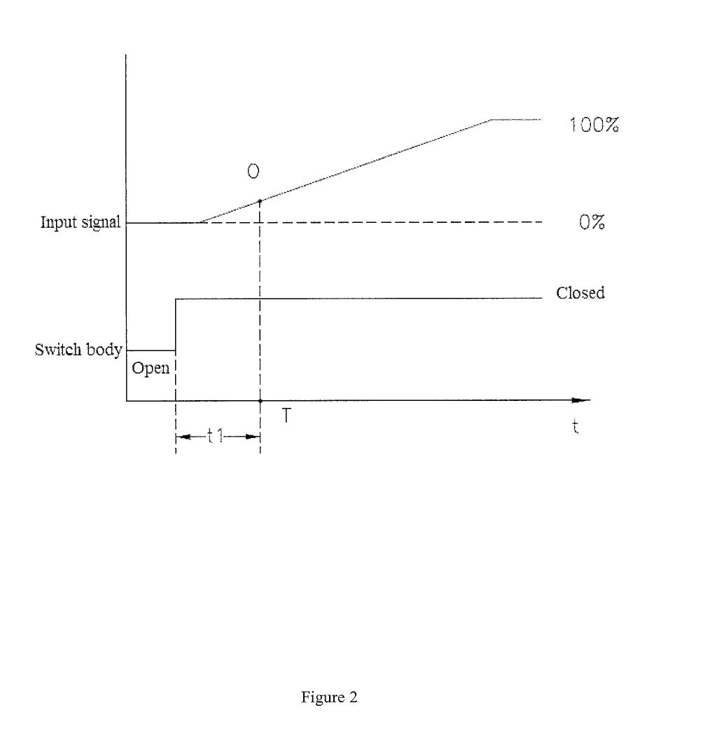

When the trigger 51 is released, the trigger 51 drives the movable contact 533 of the rheostat 53 to slide towards the second fixed contact 532, and the input signal provided by the rheostat 53 to the microcontroller 30 gradually decreases to a preset value (for example, 0 volt, 0.2 volts, or the like). When the input signal provided by the rheostat 53 to the microcontroller 30 is less than the first predetermined voltage value (for example, 0.5 volts, 0.8 volts, or the like), the microcontroller 30 outputs the brake signal to the inverter 40. When the trigger 51 is released, the trigger 51 also drives the switch body 52 to move, such that the switch body 52 is opened a first predetermined period of time t1 (for example, 5 or 8 seconds, or the like) after the microcontroller 30 outputs the brake signal (as shown in FIG. 2). In FIG. 2, a point “O” represents the input signal provided by the rheostat 53 to the microcontroller 30 at a time instant T, which causes the microcontroller 30 to output the brake signal to the inverter 40, where 0% represents the input signal provided by the rheostat 53 to the microcontroller 30 when the movable contact 533 of the rheostat 53 reaches the first fixed contact 531, which may be 0 volt, and 100% represents the input signal provided by the rheostat 53 to the microcontroller 30 when the movable contact 533 of the rheostat 53 reaches the second fixed contact 532, which may be 5 volts. In this embodiment, the trigger switch 50 further includes a delay module which is coupled with the microcontroller 30. The delay module enables the switch body 52 to be opened the first predetermined period of time t1 (for example, 5 or 8 seconds, or the like) after the microcontroller 30 outputs the brake signal.

In this embodiment, the position sensor 60 may preferably be a Hall-effect sensor, which is provided on the stator or a position within the stator close to the rotor within the motor 10, and is configured to detect a magnetic pole position of the rotor. In other embodiments, the magnetic pole position of the rotor may be detected without a sensor, instead of using the position sensor 60. In this embodiment, the position sensor 60 is coupled with the microcontroller 30.

The microcontroller 30 outputs, according to the magnetic pole position of the rotor detected by the position sensor 60, the PWM signal to control turning on and turning off of the semi-conductive switch elements in the inverter 40, to control the power mode of the motor 10 so as to drive the motor 10 to operate or stop the motor 10 from operating. The principle and the process of the microcontroller 30 controlling the inverter 40 to drive the motor 10 to operate are the same as those of a conventional controller controlling the inverter 40 to drive the motor 10 to operate, and are not described in detail herein. In this embodiment, when performing braking, the microcontroller 30 transmits the PWM signal to alternately control each two of the semi-conductive switch elements of the upper-half bridge to be turned on and each two of the semi-conductive switch elements of the lower-half bridge to be turned on. The motor stator winding and the turned-on semi-conductive switch elements form a circuit, in which a phase current is generated. A direction of the phase current is the same as that of the back electromotive force generated by the motor stator winding when the motor rotates. At this time, the phase current is capable of hindering the rotation of the motor 10, thereby implementing braking of the motor 10. Meanwhile, when performing braking, each two of the semi-conductive switch elements of the upper-half bridge and each two of the semi-conductive switch elements of the lower-half bridge are alternately controlled to be turned on, thereby preventing burnout of the semi-conductive switch element due to a long on-period.

Specifically, in this embodiment, when performing braking, the microcontroller 30 transmitting the PWM signal to alternately control each two of the semi-conductive switch elements of the upper-half bridge to be turned on and each two of the semi-conductive switch elements of the lower-half bridge to be turned on includes: the microcontroller 30 alternately controls each two of the semi-conductive switch elements of the lower-half bridge of the inverter 40 to be turned on during a first half of a rotation cycle of the motor 10, and each two of the semi-conductive switch elements of the upper-half bridge of the inverter 40 to be turned on during a second half of the rotation cycle of the motor 10.

In other embodiments, when performing braking, the microcontroller 30 transmitting the PWM signal to alternately control each two of the semi-conductive switch elements of the upper-half bridge to be turned on and each two of the semi-conductive switch elements of the lower-half bridge to be turned on includes: the microcontroller 30 alternately controls each two of the semi-conductive switch elements of the upper-half bridge of the inverter 40 to be turned on during the first half of the rotation cycle of the motor 10, and each two of the semi-conductive switch elements of the lower-half bridge of the inverter 40 to be turned on during the second half of the rotation cycle of the motor 10; or, the microcontroller 30 alternately control two semi-conductive switch elements of the upper-half bridge of the inverter 40 to be turned on and two semi-conductive switch elements of the lower-half bridge of the inverter 40 to be turned on.

In other embodiments, when performing braking, the microcontroller 30 transmits the PWM signal to control only the semi-conductive switch elements of the lower-half bridge to be turned on, so as to generate the phase current.

In the following, an operation principle of the motor drive system is described.

When the trigger 51 is pressed, the trigger 51 drives the switch body 52 to be closed. The switch body 52 connects the power supply 20 with the microcontroller 30, such that the power supply 20 supplies power to the microcontroller 30 via the switch body 52. Meanwhile, when the trigger 51 is pressed, the trigger 51 drives the movable contact 533 of the rheostat 53 to slide towards the first fixed contact 531, and the input signal provided by the rheostat 53 to the microcontroller 30 is changed to different voltage values according to different forces applied to the trigger 51. When the input signal provided by the rheostat 53 to the microcontroller 30 is greater than the first predetermined voltage value, the microcontroller 30 outputs, according to the input signal and the magnetic pole position of the rotor detected by the position sensor 60, the PWM signal to control the inverter 40 to drive the motor 10 to operate.

When the trigger 51 is released, the trigger 51 drives the movable contact 533 of the rheostat 53 to slide towards the second fixed contact 532, and the input signal provided by the rheostat 53 to the microcontroller 30 gradually decreases. When the input signal provided by the rheostat 53 to the microcontroller 30 is less than the first predetermined voltage value, the microcontroller 30 outputs the brake signal to the inverter 40 according to the input signal, such that the inverter 40 drives the motor 10 to stop operating. The switch body 52 is opened the first predetermined period of time t1 (for example, t5 or 8 seconds, or the like) after the microcontroller 30 outputs the brake signal. The switch body 52 disconnects the power supply 20 and the microcontroller 30 from each other, such that the power supply 20 stops supplying power to the microcontroller 30. The first predetermined time instant is set by a user or is a system default value. The motor 10 stops operating the first predetermined period of time t1 after the microcontroller 30 outputs the brake signal. Only then the switch body 52 is opened, and the power supply 20 stops supplying power to the microcontroller 30, thereby preventing the motor 10 from being unable to quickly stop operating due to inertia. In addition, the microcontroller 30 is powered off after the motor 10 stops rotating.

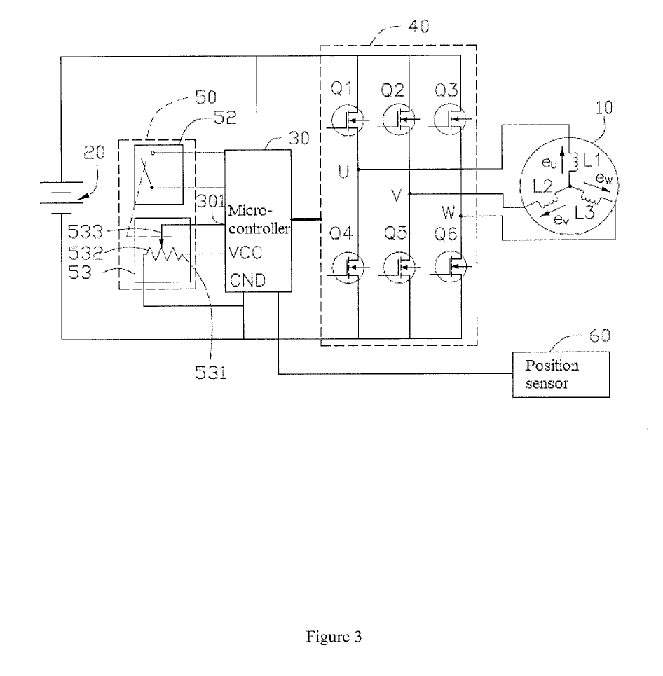

In one embodiment, the number of motor stator windings is at least two (as shown in FIG. 3). When the motor 10 performs braking, the microcontroller 30 determines a first motor stator winding with a maximum back electromotive force and a second motor stator winding with a minimum back electromotive force according to the magnetic pole position of the rotor of the motor. The microcontroller 30 transmits the PWM signal to alternately control the semi-conductive switch elements of the upper-half bridge and the semi-conductive switch elements of the lower-half bridge to be turned on, where the turned-on semi-conductive switch elements of the upper-half bridge includes a first semi-conductive switch element which controls the first motor stator winding and a second semi-conductive switch element which controls the second motor stator winding, and the turned-on semi-conductive switch elements of the lower-half bridge includes a third semi-conductive switch element which controls the first motor stator winding and a fourth semi-conductive switch element which controls the second motor stator winding, the first motor stator winding and the second motor stator winding being shorted with each other via the turned-on first semi-conductive switch element and the turned-on second semi-conductive switch element or being shorted with each other via the turned-on third semi-conductive switch element and the turned-on fourth semi-conductive switch element. The phase current is generated by the back electromotive forces generated by the first motor stator winding and the second motor stator winding. Since the first motor stator winding with the maximum back electromotive force and the second motor stator winding with the minimum back electromotive force are turned on, a voltage difference formed between the first motor stator winding and the second motor stator winding is maximum. Therefore, the phase current flowing through the first motor stator winding and the second motor stator winding is maximum; and the generated braking torque is maximum, thus the motor 10 can perform braking more rapidly.

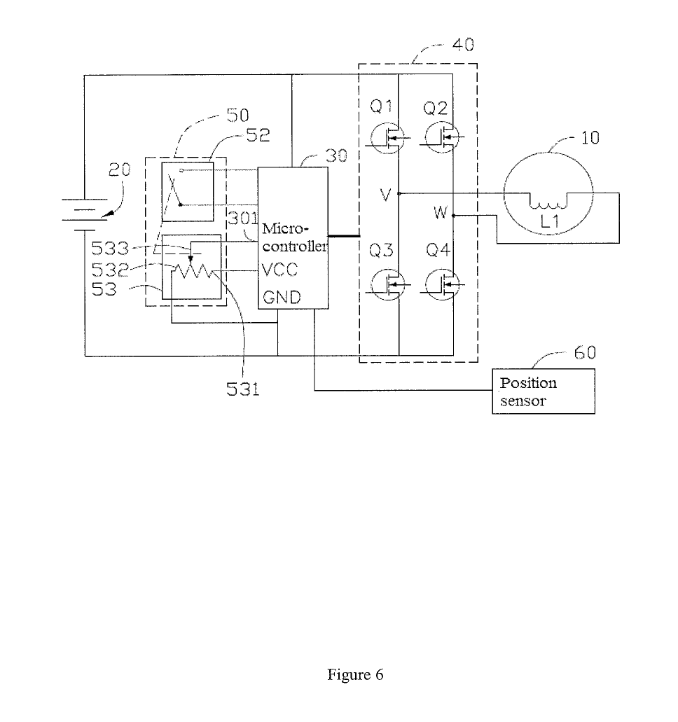

In another embodiment, the number of the motor stator windings is one (as shown in FIG. 6). In this case, the number of the semi-conductive switch elements of the upper-half bridge is two, and the number of the semi-conductive switch elements of the lower-half bridge is two. When the motor 10 performs braking, the microcontroller 30 outputs, according to the magnetic pole position of the rotor detected by the position sensor 60, the PWM signal to alternately control the two semi-conductive switch elements of the upper-half bridge to be turned on and the two semi-conductive switch elements of the lower-half bridge to be turned on. The motor stator winding and the turned-on semi-conductive switch elements form a circuit, in which the phase current is generated. The direction of the phase current is the same as that of the back electromotive force generated by the motor stator winding when the motor 10 rotates.

Referring to FIG. 3, which is a circuit diagram of the motor drive system according to one embodiment. The inverter 40 is a three-phase full-bridge inverter 40 consisting of semi-conductive switch elements Q1 to Q6, where the semi-conductive switch elements Q1 to Q3 form the upper-half bridge, and the semi-conductive switch elements Q4 to Q6 form the lower-half bridge. A first phase current is outputted to the motor stator winding L1 via a node between the semi-conductive switch element Q1 and the semi-conductive switch element Q4, a second phase current is outputted to the motor stator winding L2 via a node between the semi-conductive switch element Q2 and the semi-conductive switch element Q5, and a third phase current is outputted to the motor stator winding L3 via a node between the semi-conductive switch element Q3 and the semi-conductive switch element Q6.

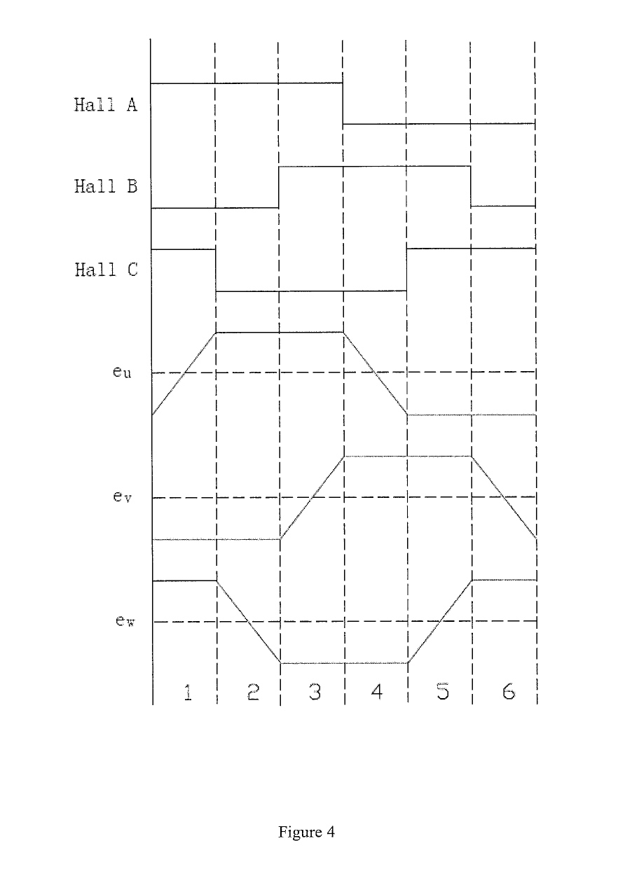

Reference is also made to FIG. 4, which is a schematic diagram illustrating waveforms of the Hall signals and the back electromotive forces according to one embodiment. In FIG. 4, the motor 10 rotates forwardly, the number of position sensors 60 is 3, and the position sensors 60 are positioned 120 degrees from each other, for example. When the motor 10 is driven to operate, the microcontroller 30 outputs, according to the Hall signals outputted by the position sensors 60, the PWM signal to control the turning on and turning off of the semi-conductive switch elements in the inverter 40, so as to control the power mode of the motor 10, thereby driving the motor 10 to operate. The principle and the process of this operation are the same as those of the operation performed by a conventional electric controller, and are not described in detail herein. In FIG. 4, reference numerals 1, 2, 3, 4, 5, and 6 respectively represent sector 1, sector 2, sector 3, sector 4, sector 5 and sector 6; Hall A, Hall B and Hall C are Hall signals respectively outputted by 3 position sensors 60; eᵤ, eᵥ and e_{w} are back electromotive forces respectively generated by the motor stator winding L1, the motor stator winding L2 and the motor stator winding L3. When the rotor of the motor is located in a certain sector, the position sensors 60 output corresponding Hall signals. Therefore, the sectors and the Hall signals outputted by the position sensors 60 have a one-to-one correspondence, and the back electromotive forces and the positions of the rotor of the motor have a one-to-one correspondence. Further, the Hall signals outputted by the position sensors 60 may indicate the positions of the rotor of the motor. Therefore, the back electromotive forces can be determined according to the Hall signals outputted by the position sensors 60.

The microcontroller 30 performs PWM modulation on the upper-half bridge or the lower-half bridge of the inverter 40 according to the Hall signals, so as to perform braking. In this embodiment, the correspondence between the sectors, the Hall signals and the turned-on semi-conductive switch elements is shown in Table 1.

TABLE 1

| | Sectors | | | | | |
|---|---|---|---|---|---|---|
| | 1 | 2 | 3 | 4 | 5 | 6 |
| Hall signals | 101 | 100 | 110 | 010 | 011 | 001 |
| Turned-on | Q5Q6 | Q4Q5 | Q4Q6 | Q2Q3 | Q1Q2 | Q1Q3 |
| semi- | | | | | | |
| conductive | | | | | | |
| switch | | | | | | |
| elements | | | | | | |

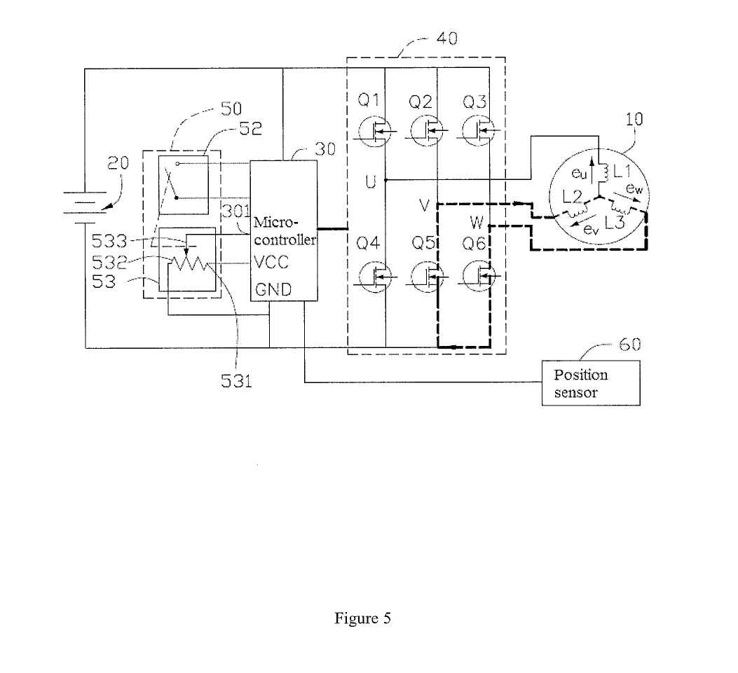

When the rheostat 53 triggers the microcontroller 30 to perform braking, the position sensors 60 sense that the magnetic pole position of the rotor is in the sector 1 and output the Hall signal 101, the first motor stator winding in the motor with the maximum back electromotive force is the motor stator winding L3, and the second motor stator winding with the minimum back electromotive force is the motor stator winding L2. At this time, the first semi-conductive switch element which controls the first motor stator winding and the second semi-conductive switch element which controls the second motor stator winding in the lower-half bridge are the semi-conductive switch element Q6 and the semi-conductive switch element Q5. The microcontroller 30 turns on the semi-conductive switch element Q6 and the semi-conductive switch element Q5. In this case, the motor stator winding L2, the motor stator winding L3, the turned-on semi-conductive switch element Q5 and the turned-on semi-conductive switch element Q6 form a circuit (as shown in FIG. 5), in which the phase current is generated. Since eᵥ<0, e_{w}>0, which are the minimum back electromotive force and the maximum back electromotive force respectively, the voltage difference formed between the motor stator winding L3 and the motor stator winding L2 is maximum, the generated phase current is maximum, and the generated braking torque is maximum. The rotation speed of the motor 10 is reduced. When the rotor moves to the sector 2, the position sensors 60 output the Hall signal 100. In this case, the process and the principle of the motor performing braking are the same as those of the motor performing braking when the rotor is in the sector 1. By analogy, the motor 10 cyclically turns on the semi-conductive switch elements in the order listed in Table 1, so as to perform braking till the motor 10 stops rotating.

In this embodiment, when the rheostat 53 triggers the microcontroller 30 to perform braking, the rotor may be located in other sectors, for example, the sector 2, where the position sensors 60 output the Hall signal 100 corresponding to this sector, and the microcontroller 30 outputs the brake signal corresponding to the Hall signal 100. At this time, when the motor 10 rotates, the microcontroller 30 cyclically turns on the semi-conductive switch elements not in the order listed in Table 1, but in the following order: Q4Q5, Q4Q6, Q5Q6, Q1Q2, Q1Q3, Q2Q3. In other embodiments, the microcontroller 30 cyclically turns on the semi-conductive switch elements in the order listed in Table 1, for example, in the following order: Q4Q5, Q4Q6, Q2Q3, Q1Q2, Q1Q3, Q5Q6.

In other embodiments, the microcontroller 30 may not alternately control each two of the semi-conductive switch elements of the lower-half bridge of the inverter 40 to be turned on during the first half of the rotation cycle of the motor 10, and each two of the semi-conductive switch elements of the upper-half bridge of the inverter 40 to be turned on during the second half of the rotation cycle of the motor 10. The microcontroller 30 may also alternately control each two of the semi-conductive switch elements of the upper-half bridge to be turned on and each two of the semi-conductive switch elements of the lower-half bridge to be turned on. For example, the microcontroller 30 cyclically turns on the semi-conductive switch elements in the following order: Q5Q6, Q1Q2, Q4Q6, Q2Q3, Q4Q5, Q1Q3.

Reference is made to FIG. 6, which is a circuit diagram of the motor drive system according to another embodiment. In the embodiment, the number of position sensors 60 is 2. The inverter 40 is a single-phase inverter consisting of semi-conductive switch elements Q1 to Q4, where semi-conductive switch elements Q1 and Q2 form the upper-half bridge, and the semi-conductive switch elements Q3 and Q4 form the lower-half bridge. The phase current is outputted to the motor stator winding L1 via a node between the semi-conductive switch element Q1 and the semi-conductive switch element Q3, and a node between the semi-conductive switch element Q2 and the semi-conductive switch element Q4.

The microcontroller 30 performs PWM modulation on the upper-half bridge or the lower-half bridge of the inverter 40 according to the Hall signals, thereby implementing braking. In this embodiment, the correspondence between the sectors, the Hall signals and the turned-on semi-conductive switch elements is shown in Table 2.

TABLE 2

Sectors

| | 1 | 2 |
|---|---|---|
| Hall signals | 10 | 01 |
| Turned-on semi-conductive | Q3Q4 | Q1Q2 |
| switch elements | | |

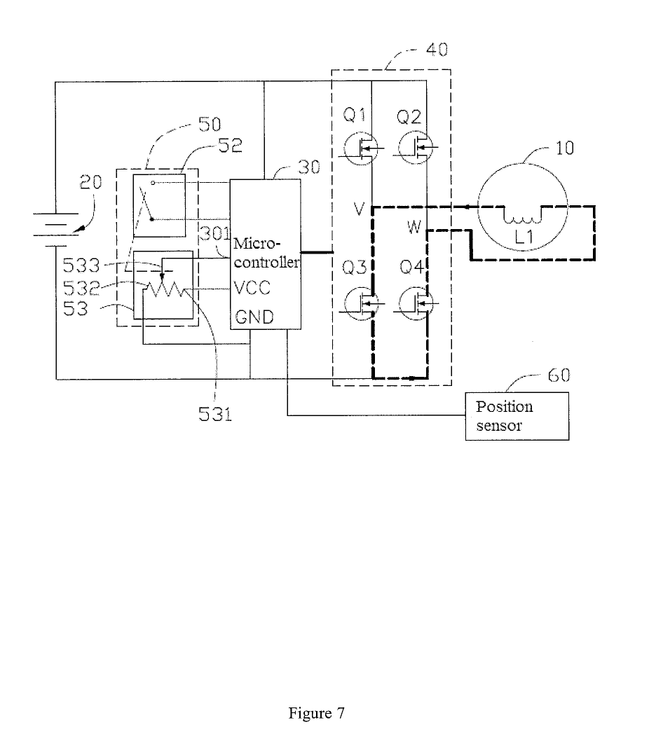

When the rheostat 53 triggers the microcontroller 30 to perform braking, the position sensors 60 sense that the magnetic pole position of the rotor is in the sector 1 and output the Hall signal 10, the microcontroller 30 turns on the semi-conductive switch element Q3 and the semi-conductive switch element Q4. In this case, the motor stator winding L1, the turned-on semi-conductive switch element Q3 and the turned-on semi-conductive switch element Q4 form a circuit (as shown in FIG. 7), in which the phase current is generated, thereby performing braking. The rotation speed of the motor 10 is reduced. When the rotor moves to the sector 2, and the position sensors 60 output the Hall signal 01, the process and the principle of the motor 10 performing braking are the same as those of the motor 10 performing braking when the rotor is in the sector 1. By analogy, the motor 10 cyclically turns on the semi-conductive switch elements in the order listed in Table 2, so as to perform braking till the motor 10 stops operating.

Practically, when the microcontroller 30 receives an opening signal, the rotor may also be located in other sectors, for example, the sector 2, where the position sensors 60 output the Hall signal 01 corresponding to this sector, and the microcontroller 30 outputs the brake signal corresponding to the Hall signal 01. At this time, when the motor 10 rotates, the microcontroller 30 cyclically turns on the semi-conductive switch elements not in the order listed in Table 2, but in the following order: Q1Q2, Q3Q4. In other embodiments, the microcontroller 30 may not alternately control the semi-conductive switch elements of the upper-half bridge of the inverter 40 to be turned on during the first half of the rotation cycle of the motor 10, and the semi-conductive switch elements of the lower-half bridge of the inverter 40 to be turned on during the second half of the rotation cycle of the motor 10. The microcontroller 30 may also alternately control the two semi-conductive switch elements of the upper-half bridge of the inverter 40 to be turned on and the two semi-conductive switch elements of the lower-half bridge of the inverter 40 to be turned on. For example, the microcontroller 30 cyclically turns on the semi-conductive switch elements in the following order: Q1Q2, Q3Q4.

Practically, the motor drive system is not limited to the above embodiments. In other embodiments, the structure and the principle of the motor drive system are generally the same as those of the motor drive system in the above embodiments, and only the differences will be explained in the following.

In another embodiment, unlike the above embodiment where the first fixed contact 531 and the second fixed contact 532 are respectively coupled with the power supply terminal VCC and the ground terminal GROUND of the microcontroller 30, the first fixed contact 531 and the second fixed contact 532 are respectively coupled with the ground terminal GROUND and the power supply terminal VCC of the microcontroller 30. Correspondingly, when the trigger 51 is pressed, the trigger 51 drives the movable contact 533 to slide towards the second fixed contact 532; and when the trigger 51 is released, the trigger 51 drives the movable contact 533 to slide towards the first fixed contact 531. The microcontroller 30 outputs the brake signal to the inverter 40 not when the input signal provided by the rheostat 53 to the microcontroller 30 is less than the first predetermined voltage value (for example, 0.5 volts, 0.8 volts, or the like), but when the input signal provided by the rheostat 53 to the microcontroller 30 is greater than a second predetermined voltage value (for example, 4 volts, 5 volts, or the like). In addition, the microcontroller 30 adjusts the duty cycle of the PWM signal generated by the microcontroller 30 according to the input signal not when the input signal provided by the rheostat 53 to the microcontroller 30 is greater than the first predetermined voltage value, but when the input signal provided by the rheostat 53 to the microcontroller 30 is less than the second predetermined voltage value (for example, 4 volts, 5 volts, or the like).

In another embodiment, when the trigger 51 is released, the trigger 51 can drive the switch body 52 to be opened for a second predetermined period of time after the trigger 51 is released, without being limiting to the above described driving the switch body 52 to move such that the switch body 52 is opened after the microcontroller 30 outputs the brake signal for the first predetermined period of time (for example, 5 or 8 seconds, or the like). In this embodiment, the delay module enables the switch body 52 to be opened after the trigger 51 is released for the second predetermined period of time.

In another embodiment, unlike the above embodiment where the input signal provided by the rheostat 53 to the microcontroller 30 reaches different preset values according to different forces applied when the trigger 51 is pressed, such that the rotation speed of the motor 10 varies with the forces applied on the trigger 51, the input signal provided by the rheostat 53 to the microcontroller 30 gradually increases to a preset value (for example, 5 volts), such that the rotation speed of the motor 10 gradually increases to a set value (for example, 700 rpm) when the trigger 51 is pressed.

FIG. 8 is a schematic diagram illustrating a power tool, for example, an electric dill, to which the above motor drive system is applied. The electric drill 100 includes a housing 110, a working head 120 extended out of the housing 110, the motor 10 and the motor drive system as described above provided within the housing 110. The trigger 51, which is configured to control turning on and turning off of the electric drill, is arranged on a handle at a lower portion of the housing 110 and is manually operable by a user. When the trigger 51 is pressed, the electric drill is turned on, and when the trigger 51 is released, the electric drill is turned off. The above motor drive system is also applicable to power tools such as an electric screw driver, a hand mill and an electric saw.

What is described above is only preferred embodiments of the invention and is not intended to define the scope of protection of the present disclosure. Any changes, equivalent substitution, improvements and so on made within the spirit and principles of the present disclosure shall fall in the scope of protection of the present disclosure.

1. A motor drive system, comprising:
an inverter coupled with two terminals of a power supply, wherein the inverter comprises a plurality of semi-conductive switch elements, and is configured to convert a voltage provided by the power supply to an alternating current to drive a motor;
a microcontroller configured to output a drive signal to control a power mode of the plurality of semi-conductive switch elements in the inverter; and
a rheostat coupled with the microcontroller and configured to provide an input signal to the microcontroller by sliding, wherein the microcontroller outputs a brake signal to the inverter to control the motor to stop operating when the input signal meets a predetermined condition, and the microcontroller is powered off when the motor stops rotating.

2. The motor drive system according to claim 1, wherein:
the microcontroller outputs the brake signal to the inverter when the input signal provided by the rheostat to the microcontroller is less than a first predetermined voltage value.

3. The motor drive system according to claim 2, wherein:
the rheostat comprises a first fixed contact, a second fixed contact and a movable contact, the first fixed contact and the second fixed contact being respectively coupled with a power supply terminal and a ground terminal of the microcontroller, and the movable contact being coupled with an input terminal of the microcontroller, wherein different input signals are provided by the rheostat to the microcontroller by the movable contact sliding towards the first fixed contact or the second fixed contact, wherein the input signal gradually increases when the movable contact slides towards the first fixed contact, and gradually decreases when the movable contact slides towards the second fixed contact.

4. The motor drive system according to claim 2, wherein:
when the input signal provided by the rheostat to the microcontroller is greater than the first predetermined voltage value, the microcontroller adjusts, according to the input signal, a duty cycle of a PWM signal outputted by the microcontroller to adjust a rotation speed of the motor.

5. The motor drive system according to claim 1, wherein:
the microcontroller outputs the brake signal to the inverter when the input signal provided by the rheostat to the microcontroller is greater than a second predetermined voltage value.

6. The motor drive system according to claim 5, wherein:
the rheostat comprises a first fixed contact, a second fixed contact and a movable contact, the first fixed contact and the second fixed contact being respectively coupled with a ground terminal and a power supply terminal of the microcontroller, and the movable contact being coupled with an input terminal of the microcontroller, wherein different input signals are provided by the rheostat to the microcontroller by the movable contact sliding towards the first fixed contact or the second fixed contact, wherein the input signal gradually decreases when the movable contact slides towards the first fixed contact, and gradually increases when the movable contact slides towards the second fixed contact.

7. The motor drive system according to claim 5, wherein:
when the input signal provided by the rheostat to the microcontroller is less than the second predetermined voltage value, the microcontroller adjusts, according to the input signal, a duty cycle of a PWM signal outputted by the microcontroller to adjust a rotation speed of the motor.

8. The motor drive system according to claim 1, wherein:
the inverter comprises an upper-half bridge and a lower-half bridge, each of the upper-half bridge and the lower-half bridge comprises at least two semi-conductive switch elements, and when performing braking, the microcontroller transmits a PWM signal to alternately control each two of the at least two semi-conductive switch elements of the upper-half bridge to be turned on and each two of the at least two semi-conductive switch elements of the lower-half bridge to be turned on, wherein a motor stator winding of the motor and the turned-on semi-conductive switch elements form a circuit.

9. The motor drive system according to claim 8, wherein:
the microcontroller alternately controls each two of the at least two semi-conductive switch elements of the lower-half bridge of the inverter to be turned on during a first half of a rotation cycle of the motor, and each two of the at least two semi-conductive switch elements of the upper-half bridge of the inverter to be turned on during a second half of the rotation cycle of the motor.

10. The motor drive system according to claim 8, wherein:
when a number of the motor stator winding of the motor is at least two, when performing braking, the microcontroller determines a first motor stator winding which generates a maximum back electromotive force and a second motor stator winding which generates a minimum back electromotive force according to a magnetic pole position of a rotor of the motor, and transmits the PWM signal to alternately control semi-conductive switch elements of the upper-half bridge and semi-conductive switch elements of the lower-half bridge to be turned on, wherein the turned-on semi-conductive switch elements of the upper-half bridge comprises a first semi-conductive switch element which controls the first motor stator winding and a second semi-conductive switch element which controls the second motor stator winding, and the turned-on semi-conductive switch elements of the lower-half bridge comprises a third semi-conductive switch element which controls the first motor stator winding and a fourth semi-conductive switch element which controls the second motor stator winding, whereby the first motor stator winding and the second motor stator winding are shorted with each other via the turned-on first semi-conductive switch element and the turned-on second semi-conductive switch element or shorted with each other via the turned-on third semi-conductive switch element and the turned-on fourth semi-conductive switch element.

11. The motor drive system according to claim 10, further comprising:
a position sensor configured to output a Hall signal according to the magnetic pole position of the rotor, the upper-half bridge comprises a first switch, a second switch and a third switch, and the lower-half bridge comprises a fourth switch, a fifth switch and a sixth switch, wherein a node is formed between the first switch and the fourth switch, a node is formed between the second switch and the fifth switch, and a node is formed between the third switch and the sixth switch, and wherein the microcontroller turns on the fifth switch and the sixth switch when the Hall signal outputted by the position sensor is 101, turns on the fourth switch and the fifth switch when the Hall signal outputted by the position sensor is 100, turns on the fourth switch and the sixth switch when the Hall signal outputted by the position sensor is 110, turns on the second switch and the third switch when the Hall signal outputted by the position sensor is 010, turns on the first switch and the second switch when the Hall signal outputted by the position sensor is 011, and turns on the first switch and the third switch when the Hall signal outputted by the position sensor is 001.

12. The motor drive system according to claim 8, wherein:
when a number of the motor stator winding of the motor is one, when performing braking, the microcontroller transmits the PWM signal according to a magnetic pole position of a rotor, so as to alternately control semi-conductive elements of the upper-half bridge to be turned on and semi-conductive elements of the lower-half bridge to be turned on, the motor stator winding and the turned-on semi-conductive elements forming a circuit.

13. The motor drive system according to claim 12, further comprising:
a position sensor configured to output a Hall signal according to the magnetic pole position of the rotor, wherein the inverter comprises an upper-half bridge and a lower-half bridge, the upper-half bridge comprises a first switch and a second switch, and the lower-half bridge comprises a third switch and a fourth switch, wherein a node is formed between the first switch and the third switch, and a node is formed between the second switch and the fourth switch, and wherein the microcontroller turns on the third switch and the fourth switch when the Hall signal outputted by the position sensor is 10, and turns on the first switch and the second switch when the Hall signal outputted by the position sensor is 01.

14. The motor drive system according to claim 1, further comprising:
a switch body which is coupled between the power supply and the microcontroller, and is configured to be opened after the microcontroller outputs the brake signal for a first predetermined period of time, wherein when the motor stops rotating, the switch body disconnects the power supply and the microcontroller from each other, and the power supply stops supplying power to the microcontroller.

15. The motor drive system according to claim 14, further comprising:
a trigger configured to drive the switch body and the rheostat to move when manually operated by a user, wherein when the trigger is pressed, the trigger drives the switch body to be closed and the switch body connects the power supply with the microcontroller, and drives the rheostat to move and the microcontroller adjusts, according to the input signal provided by the rheostat to the microcontroller, a duty cycle of a PWM signal outputted by the microcontroller, to adjust a rotation speed of the motor; and when the trigger is released, the trigger drives the rheostat to move and the input signal provided by the rheostat to the microcontroller triggers the microcontroller to output the brake signal, and drives the switch body to move such that the switch body is opened after the microcontroller outputs the brake signal for the first predetermined period of time.

16. The motor drive system according to claim 1, further comprising:
a switch body coupled between the power supply and the microcontroller, and a trigger configured to drive the switch body to move when manually operated by a user, wherein when the trigger is released, the trigger drives the switch body to be opened after the trigger is released for a second predetermined period of time, wherein when the motor stops rotating, the switch body disconnects the power supply and the microcontroller from each other, and the power supply stops supplying power to the microcontroller.

17. A power tool, comprising: a housing, a working head extended out of the housing, a motor for driving the working head, and the motor drive system according to claim 1.
